(19) United States
(12) Patent Application Publication
(10) Pub. No.: US 2001/0038596 A1
(43) Pub. Date: Nov. 8, 2001

(54) Multi-wavelength optical disc, apparatus and method for reading and writing signal therefor

(76) Inventors: Duanyi Xu, Beiging (CN); Xianfu Cheng, Beiging (CN); Ningfang Liao, Beiging (CN); Mali Gong, Beiging (CN); Guosheng Qi, Beiging (CN); Ping Yan, Beiging (CN); Hexiong Li, Beiging (CN); Lijun Ma, Beijing (CN)

Correspondence Address: RATNER & PRESTIA, P O BOX 980, VALLEY FORGE, PA, 19482

(21) Appl. No.: 09/810,948

(22) Filed: Mar. 16, 2001

(30) Foreign Application Priority Data
Mar. 17, 2000 (CN) 00103230.5
Mar. 17, 2000 (CN) 00103231.3
Mar. 24, 2000 (CN) 00103501.0
Jun. 9, 2000 (CN) 00109128.X

(51) Int. Cl. G11B 7/135; G11B 7/24

(52) U.S. Cl. 369/94; 369/285; 369/121; 369/112.28

(57) ABSTRACT

This invention relates to a multi-wavelength optical disc and an apparatus and method to read or write signal therefor. The multi-wavelength optical disc comprises a substrate and a recording layer comprising various photochromic materials to store more data, and a reflective layer on the recording layer. The apparatus comprises at least one monochromic sources to generate a monochromic light beam, each with different wavelengths, a beam combiner to combine the light beams to a coaxial parallel light beam containing various light signals with different wavelengths, and a beam focalizer to focus the light beam on the optical disc. The apparatus also comprises a beam splitter and light detector to read the data recorded on the disc. When the apparatus reads data from the optical disc, the beam receiver receives the light beam reflected by the optical disc, and the beam splitter decomposing the reflected parallel light beam to monochromic signals with different wavelengths, then the optical detector detects each monochromic signal.

### FIELD OF THE INVENTION

This invention relates to the field of optical storage technology, and particularly relates to an optical disc and an apparatus and method for reading and writing signal therefor.

### BACKGROUND OF THE INVENTION

Optical storage is one of the main methods for information data storage. With the rapid increase of the quantity of information, a hugh capacity optical storage is needed, therefore, a fast reading and writing method and apparatus thereof are also needed. In order to improve effectively the capacity of optical storage, one way is to increase the storage dimensionality, such as increasing data recording layers, recording with multi-wavelength or decreasing the spot size. For example, DVD-ROM increases the recording layers to improve its capacity, such DVD-ROM is showed in FIG. 1. A dual layer (single sided) DVD disc comprises a upper first recording layer 171, a semi reflective layer 2A, a lower second recording layer 172, a reflective layer 18, a protective layer 19 and a dummy substrate 6A. The upper first recording layer 171 and lower second recording layer 172 are stamped to record information data. The reflection index of the semi-reflective layer 2A is about 30% (i.e. 30% light will be reflected), and the reflective index of reflective layer 18 is greater than 70%.

FIG. 2 shows a process for reading data stored in the disc. When the data recorded on the upper layer 171 needs to be read, the light beam generated by laser diode 7 is sent to the polarizing beam splitter 13 to process it, then the processed beam is sent to the objective lens 15 through which the light beam is focused on the upper first recording layer 171. Then the light beam is modulated by the first recording layer 171 with the information recorded on the first recording layer 171. This modulated light beam is reflected by the semi-reflective layer 2A to the objective lens 15, and then to the polarizing beam splitter 13. At last, the detector 11 detects the reflected modulated light beam to recover the recorded data and the servo signals. When data on the lower recording layer 172 needs to be read, the objective lens 15 is moved down to have part (70%) of light the focused on the lower recording layer 172 through the semi-reflective layer 2A and reflected by the reflective layer 18. Part of the reflected light goes through the semi-reflective layer 2A and is received by the detector 11, which generates the recorded data and servo signals. This method has the following shortages: firstly, it requires complex techniques in disc production. Secondly, after the upper recording layer 171 being stamped and the semi-reflective layer 2A being coated, it needs to stamp the lower recording layer 172 on these completed layers and this process may cause some damages to the upper recording layer 171 and caused lower yield. Thirdly, It is difficult to have more than two layers in a disc by this way, because there must be a corresponding reflective layer and stamp layer for each recording layer, and the readout signal will be rapidly weaken. For example, the reflective index of the first layer in the dual layer disc is about 30%, and this means the amplitude of the readout signal is less than ⅓ of the initial value. Fourthly, the information read-out and write-in on the disc is carried out layer by layer serially with single laser bean at one time, thus the read-write speed is limited. Finally, at the present time each layer has different ratio of transmissivity to reflectivity, so it is difficult to use more than two recording layers and improve the storage dimensionality and capacity.

If various multi-wavelength signals can be recorded on the same tract of an optical disc, the recording density can be increased, and then this requires a multi-wavelength optical disc and corresponding apparatus and method for parallel information reading and writing on the optical disc.

In present optical pickup technology, there are some structures, using diffraction grating or multicolor light filter, to split the read-write beam. For example, in the three-beam DVD or VCD optical pickups, diffraction gratings are widely used to split the laser beam. And in the dual-wavelength DVD optical pickups, compatible with VCD, someone choused wavelength-selective light filters; And in the No. 90103626.2 Patent of China, a concave diffraction gratings is used to split the scan beam, which can read the recording signals on certain side of the optical disc. But all of the techniques mentioned above do not involved the parallel read problem in the depth direction in multi-wavelength record on optical disc.

Additionally, the traditional way to improve the density of optical disc storage is to decrease the spot size of the read write beam. Generally the spot size of the focused beam is limited by the diffraction effect of the laser beam: the half-intensity diameter DIA_{FWHM} is in direct proportion to the laser wavelength λ and inverse proportion to the digital aperture NA of the pickup's objective lens:

$${DIA}_{FWHM} = \frac{λ}{λ NA}$$

So, there are two main ways to decrease the spot size of the focused beam:

First, decrease the laser's wavelength. For example, in the newest present high-density DVD optical disc, the laser's wavelength has been decrease from 780 nm to 670 nm. But because it is rather difficult to develop more shutter wavelength laser apparatus and the substrate of the disc seriously weakens the transmission ratio of the short wavelength laser, decreasing the wavelength is restricted.

Second, increase the digital aperture of the optical pickup's objective lens. Fox example, in the high density DVD optical disc, the digital aperture has been increased form 0.45, which is used in CD discs, to 0.6. But to manufacture a non-spherical lens with high digital aperture used in optical storage system is a rather difficult technique. At the same time, based on the analysis of phase contrast, even the phase contrast of the objective lens has been adjusted perfectly, the variety of the thickness of the optical disc leads to the variety of the optical path length, which causes the decrease of the quality of the read-write signal.

Furthermore, the super-resolution mask technique can engender a facula whose size is less than the diffraction limit size. At the present time, the main super-resolution mask techniques are:

1.Magnetic induced super-resolution technique (MSR). M. Kaneko and his colleagues of SONY Corporation firstly proposed this idea. They used three or four magnetic media layer and achieved super-resolution effect within external magnetic field. In the way, the line density and area density of the magneto-optical disc can be improved and higher density storage may come true.

2.Super-resolution technique with phase-change material. This idea was bring forward by Yutaka Masami and others of SONY Corporation, using the reflectivity differ of the phase-change material in crystalline state and amorphous state to actualize super-resolution mask and increase the storage density.

The super-resolution mask methods mentioned above can get better read-write effect beyond the diffraction limit and enhance the storage density of the media, without changing the light path of the system. But MSR method has some limitation: besides what we have described above, the most important thing is that MSR method can only be used in a magneto-optical disc but cannot be used in a phase-change or a read-only storage material. On the other hand, all the media super-resolution discs mentioned above use the heat effect of the material, and because of the heat diffusion effect, it is very difficult to get a very little effective light spot. Simultaneity, along with the decreasing of the laser wavelength, these methods using material's heat effect to exceed the diffraction limit may be restricted.

The optical disc involved in this invention is different with existing DVD discs in disc structure and signal storage principles, which uses photochemical effect to get super-resolution. The space between the signal layers in the multi-wavelength disc is much narrower than the space in a dual-layer DVD disc. It is necessary to adopt parallel readout method for the disc to read these multi recording layers.

One object of this invention is to provide a multi-wavelength optical disc, on which various signals with different wavelengths can be parallel recorded. Another object of this invention is to provide an apparatus that can parallel read or write signals on this type of multi-wavelength optical disc and corresponding methods are provided too.

### SUMMARY OF THE INVENTION

To realize parallel writing and reading of recording signal in the depth direction (axis direction) of the multi-wavelength optical disc, an apparatus and a method is needed. While data is being read, various monochromatic lights are combined into a compound light with multi-wavelength signals, and then the compound light is focused on the recording layer and reflected by the optical disc, and then the reflected compound light is split to various corresponding monochromatic lights and reaches the detectors and generates read-out signals. When only writing data, various monochromatic lights are combined into a compound light with multi-wavelength signals, which is focused on the corresponding position. It is needed to invent such a disc and an apparatus and a method for reading and writing the disc.

According to one aspect of this invention, a multi-wavelength optical disc is provided. The disc comprising:

a substrate comprising at least one information record layer on which optical signal consisting of at least one wavelength light beam components is recorded by modulating the layer's transmissivity for each of said components, wherein the information layers located within the focal depth of a objective lens for reading the disc when the disc is being read;

a reflective layer on the substrate to reflect the modulated optical signal; and

a protective layer on the reflective layer.

Alternately, a multi-wavelength optical disc also comprises a photochromic super-resolution mask layer sandwiched between the substrate and the reflective layer, the photochromic super-resolution mask layer comprising high-order non-linear photochromic materials; the information layers and the mask layer located within the focal depth of a objective lens for reading the disc when the disc is being read.

According to another aspect of the invention, there is a kind of multi-wavelength optical disc comprising:

a substrate;

at least one recording layer on the substrate, wherein said at least one recording layer comprising at least one kind of photochromic material, said recording layers being orderly arranged one by one on the substrate if there are more than one recording layers, and said at least one recording layer located within the focal depth of a objective lens for reading the disc when the disc is being read;

a reflective layer on the recording layers to reflect the light signal modulated by the recording layer;

a protective layer on the reflective layer.

Alternately, said at least one recording layer comprises at least one kinds of organic compounds, such as spiropyran, spirooxazine, fulgide or azo, or their mixture.

Furthermore, the multi-wavelength optical disc further comprises a photochromic super-resolution mask layer, and at least one recording layer sandwiched between the photochromic super-resolution mask layer and the reflective layer; all the recording layers and the mask layer located within the focal depth of a objective lens for reading or writing the disc when the disc is being read or writen.

The photochromic super-resolution mask layer comprises at least one kind of organic compound, such as spiropyran, spirooxazine, fulgide or azo, or their mixture.

According to further another aspect of the invention, there provides a apparatus for reading or writing signal recorded on or to the multi-wavelength disc; the multi-wavelength optical disc comprises some recording layers on which some multi-wavelength optical signals have been recorded and a reflective layer on said recording layers; said apparatus comprises:

at least one monochromatic light source, and each one of said at least one monochromatic light source generating light beam with different wavelength;

a light beam combiner optically coupled to the light source for multiplying the light beam from said at least one monochromatic source to a coaxial parallel light beam containing all said different wavelengths;

a beam focalizer optically coupled to the beam combiner for having the coaxial parallel light beam focussed on all said recording layers located within the focal depth, said multi-wavelength signals recording layers being recorded on said recording layers.

According to further another aspect of the invention, there provides a apparatus for reading or writing signal recorded on or to the multi-wavelength disc comprising:

at least one monochromatic light source, and each one of said at least one monochromatic light source generating light beam with different wavelength;

a light beam combiner optically coupled to the light source for multiplying the light beam from said at least monochromatic source to a coaxial parallel light beam containing all said different wavelengths;

a beam focalizer optically coupled to the beam combiner for having the coaxial parallel light beam focussed on all said recording layers of the disc located within the focal depth, wherein said multi-wavelength signals recording layers being recorded on said recording layers;

a beam receiver optically coupled to the disc for receiving the coaxial parallel light beam reflected by the reflective layer;

a beam splitter optically coupled to the beam receiver for splitting the received coaxial parallel light beam from the beam receiver to monochromatic optical signals with different wavelengths;

at least one optical detector optically coupled to the beam splitter for detecting corresponding the split monochromatic optical signals.

According to further another aspect of the invention, a method for writing a optical signal to a multi-wavelength optical disc, the multi-wavelength optical disc comprising a multi-wavelength recording layer comprising various photochromic materials, and a reflective layer on the mentioned recording layers, the recording layer located within the focal depth of a objective lens for focussing the signal on said recording layer; said method comprises steps of:

modulating each light sources based upon the signal to be written to the disc to generate several light beams with different wavelength, wherein the intensity of the light beams being above the photochromic threshold of the photochromic materials when the beam reaches the recording layer of the optical disc;

combining said light beams to one coaxial parallel light beam with different wavelength components;

adjusting the objective lens to have the recording layers of the disc located within the focal depth to focus the coaxial parallel light beam with different wavelength on the recording layer;

writing the optical signal to the recording layer, wherein each compound of the coaxial parallel light beam with different wavelength components writing corresponding signal to the layer of the optical disc.

Alternately, each light source is modulated by a multistage modulation method.

According to further another aspect of the invention, a method for reading the data stored in a multi-wavelength optical disc, the multi-wavelength optical disc comprising a multi-wavelength recording layers comprising several kinds of photochromic materials, and a reflective layer on the recording layer, the recording layer located within the focal depth of a objective lens for focussing the signal on said recording layer; said method comprises steps of:

generating constant several light beams with different wavelength by several light source, the intensity of the beam being below the photochromic threshold of the photochromic materials when the beam reaches the recording layer of the optical disc;

combining the light beams to one coaxial parallel light beam with different wavelength components;

adjusting the objective lens to have the recording layers of the disc located within the focal depth to focus the coaxial parallel light beam with different wavelength on the recording layer;

modulating the coaxial parallel light beam by the recording layer to a modulated multi-wavelength coaxial parallel light beam, wherein different layer modulating the components with a corresponding wavelength;

splitting the modulated multi-wavelength coaxial parallel light beam with different wavelength components to several single-wavelength light beams, detecting said several single-wavelength light beams.

Alternately, said method further comprises a step of reflecting the modulated multi-wavelength coaxial parallel light beam.

The multi-wavelength optical disc of this invention realizes parallel multi-wavelength signal recording, utilizing the special recording layers comprising several photochromic materials. The spot size of the light beam is decreased by a mask layer comprising high-order non-linear photochromic materials. Therefor, the storage capacity of the optical disc is increased.

This invention also realizes the multiplex parallel read-write function on the multi wavelength optical disc and increases the read-write velocity.

### BRIEF DESCRIPTION OF THE DRAWINGS

FIG. 1 is the structure of a DVD-ROM disc.

FIG. 2 illustrates an apparatus for reading-out or writing-in the DVD-ROM disc showed in the FIG. 1.

FIG. 3 illustrates an apparatus for reading-out or writing-in a multi-wavelength optical disc of this invention.

FIG. 4 illustrates a kind of splitter with a dispersion prism.

FIG. 5 illustrates another kind of splitter with a transmission grating.

FIG. 6 illustrates still another kind of splitter with a reflective grating.

FIG. 7 illustrates one kind of the beam combiner of this invention, for reading and writing signal on the multi wavelength optical disc.

FIG. 8 illustrates another kind of the beam combiner of this invention, for reading and writing signal on the multi-wavelength optical disc.

FIG. 9 illustrates a structure of the optical disc of the invention, with only one recording layer.

FIG. 10 illustrates a structure of the optical disc of the invention, with n recording layers.

FIG. 11 is second structure of the optical disc of the invention, with n recording layers.

FIG. 12 is third structure of the optical disc of this invention, with n recording layers.

FIG. 13 is a structure of the read-only optical disc of this invention, with a mask layer between the substrate and the reflective layer.

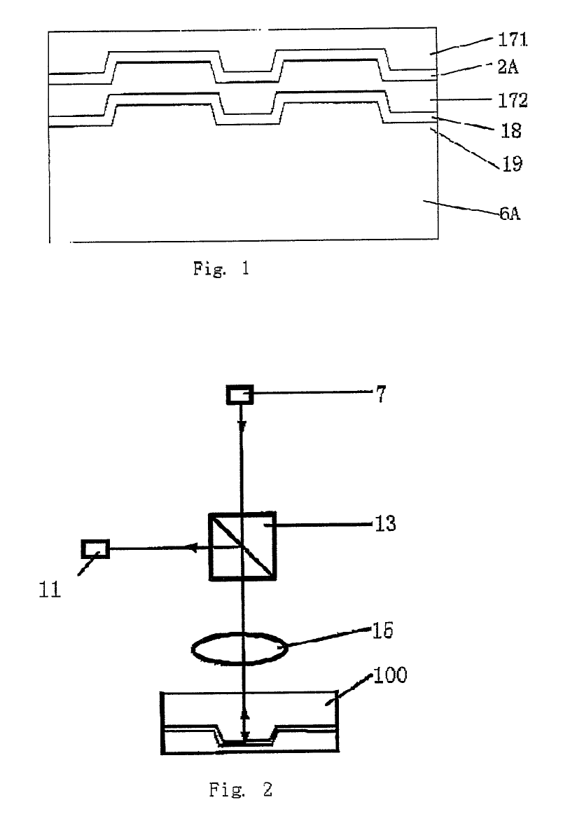

### DETAILED DESCRIPTION OF PREFERRED EMBODIMENTS

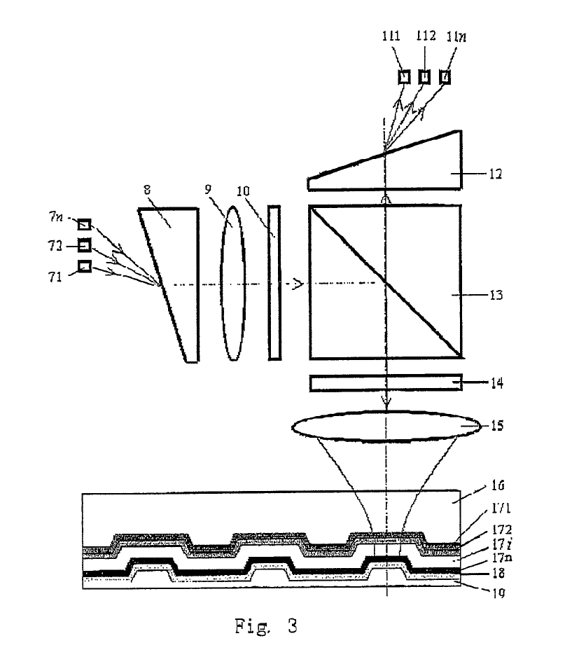

Now, refer to FIG. 3, which illustrates an apparatus for reading-out or writing-in a multi-wavelength optical disc of this invention. The multi-wavelength optical disc 100 includes a protecting layer 19, on which there is a reflecting layer 18. There are also multi recording layers 171, 172, . . . , 17i, . . . , 17n on the reflecting layer 18. Each recording layer comprises a photochromic material sensitive to the light with a certain wavelength. All of the recording layers locate within the objective len'focal depth to all applied light wavelengths. On the multi-recording layers, there is a substrate 16.

The method to write signal to the optical disc 100 comprises steps: adjusting the object lens 15's position to make the optical disc 100's all recording layers within object lens 15's focal depth. Laser diodes 71, 72, . . . , 7n, eradiate laser light with different wavelength, bλ, i−1,2, . . . ,n, respectively, wherein the amplitude of each light is sensitive to the signal to be written to the disc 100. Light beams from laser diodes 71, 72, . . . , 7n, are transited through the beam combiner 8, the focusing lens 9, and the diffraction grating 10, to form one coaxial beam. This coaxial beam passes through the light emitting equipment compressing a polarizing beam splitter 12, a λ/4 plate 14, and a APO object lens 15, and is focused on the optical disc 100's recording layers. Accordingly, signal of λᵢ wavelength acts on recording layer 17i. When a light beam reaches layer 17i, its intensity is higher than the photochromic reaction threshold Aₙ of photochromic material on layer 17i., hence, the photochromic material can record signal. When writing, multi-level quantize method also can be applied to increase information memory capacity.

To read signal recorded on the disc, first, adjusting the object lens 15's position, making the optical disc 100's all recording layers in the object lens 15's focal depth. Laser diodes 71, 72, . . . , 7n, eradiate laser light of different wavelength. λᵢ (i-1,2, . . . ,n). Beams of light from laser diodes 71, 72, . . . , 7n, are transited through a beam combiner 8, a focusing lens 9, and a diffraction grating 10, to form one coaxial beam. This coaxial beam passes through the light emitting equipment composing of a polarizing beam splitter 12, a λ/4 plate 14, and a APO object lens 15, then is focused on the optical disc 100's all recording layers. All recording layers locate in the object len 15's focusing area. The light beam of λᵢ wavelength acts on recording layer 17. When the light beam reaches layer 17i, its intensity is lower than the photochromic reaction threshold Aₙ of photochromic material comprised layer 17i. After the light beam of a wavelength being absorded, i.e. modulated, by a recording layer, the reflecting layer 18 reflects the beam which is modulated by the data information recorded in each recording layer. The signal modulated by all recording layers is still a coaxial beam, with data information recorded in each recording layer. This signal passes through light receiving device composing of an object lens 15, a λ/4 plate 14, a polarizing beam splitter 13, then enters into a beam splitter 12. The beam splitter 12 splits the signal to multi-beam signals, each with a wavelength of λᵢ (i=1,2, . . . ,n). Optical detectors 111, 112, . . . , 11n detect each of multi-beam signals, respectively.

Here, we will not describe features which are well known by the ordinary persons in the art, such as, disc addressing, disc channel, channel sector formats of the disc etc.

In addition, although each recording layer of the optical disc in this figure comprises one kind of photochromic material (i.e. each kind of material is distributed on one layer), it is known by the person in the art that all photochromic materials also can be mixed on one layer to realize same function. In other words, the function of a disc with multi-recording layer in which every recording layer comprises only one kind of photochromic material is the same as the function of the disc with only one recording layer comprising all photochromic material mixed in the layer.

A preferred method of writing data on the optical disc 100 includes the following steps:

1. Placing a optical disc 100 into the writing equipment, rotating it, moving a object lens 15 up or down to have the optical disc 100's recording layers located in the object lens 15's focal depth, and ensuring these recording layers always in the focal depth;

2. Adjusting the object lens along optical disc's radius to focus on the disc's channel; reading the format code of a sector on the channel, calculating the distance between this sector and the object sector; then moving the object lens the same distance radially, to focus on the object sector's channel.

3. Data of each channel in n channels is written in by a laser diode, light beam from each laser diode 71, 72, . . . , 7n have different wavelength, λᵢ (i=1,2, . . . ,n), these beams pass through a beam combiner 8, a focusing lens 9, a diffraction grating 10, becoming a coaxial beam. The coaxial beam goes through a light projector comprising a polarizing beam splitter 13, a λ/4 plate, a object lens 15, focused on the optical disc 100. When the disc is rotated, read out format code of every sector pass by the object lens, wait for that object sector passing by, when data storage area of that object sector passes by the focus, according to above mentioned n channel of data, let n laser diodes 71,72, . . . , 7n eradiate laser beams whose intensity change with time, each beam's intensity have m kind of value Iₙ (i=1,2, . . . ,m), so each recording layer stores with m levels, and each laser beams's intensity is higher than the photochromic reaction threshold value Ai of corresponding material in the optical disc;

4. These n beams of laser passing through the substrate are focused on the disc's n recording layers. Object lens 15 is a APO object lens, All beams of different wavelength are focused onto the same point, because these n recording layers locate in the object lens focal depth. As the disc rotates, these n channels of data are written into the optical disc's n recording layers, respectively. The object lens′ focus keeps on the object sector's channel, till the writing process completes.

5. A preferred method for reading optical disc 100 includes steps:

1.Rotating the optical disc, adjusting the object lens′ location to have the n recording layers located in the focal depth of the lens.

2. Adjusting object lens along optical disc's radius, making its focus on the disc's channel; read out the format code of a sector on the channel, and calculate the distance between this sector and the object sector to write data into; then move the object lens the same distance radially, to focus on object sector's channel.

3. When disc rotating, read out format code of every sector pass by the object lens, wait for that object sector passing by, when data storage area of that object sector passes by the focus, according to above mentioned n channel of data, let n laser diodes 71,72, . . . , 7n eradiate laser beams whose intensity change with time, each beams's intensity have m kind of value Iᵢ(l-1,2, . . . ,m), so each recording layer stores with m levels, and each laser beam's intensity is lower than the photochromic reaction threshold value Ai of corresponding material in the optical disc;

1. Laser beams of n kind of wavelength can be absorbed by the n recording layers. After absorbed by n recording layers, the above n kind of laser beams are reflected by the reflecting layer 18, then pass through sequentially a object lens 15, a λ/4 plate, a polaring beam splitter 13 which compose the light receiver. Then the beam is decomposed to n beams of laser. Detectors 111, 112, . . . , 11n, receive laser of the n kind of wavelength, respectively, and detect n kind of laser's intensity to read our data on n recording layer according to the variation of intensity. In all process, the object lens keeps focusing on the channel of object sectors, till the data reading our process completes.

In this embodiment, the servo signal can be produced by one of these laser beams. Because the λ/4 plate 14 is designed according to the servo wavelength, so when the servo beam reaches the optical disc's servo groove, it becomes a elliptic polarizing light. Beam of light returning from the servo groove passes through λ/4 plate 14 again, the turns into linear polarizing light again, but its phase changes by 180 degree, so it can pass the polarizing beam splitter to reach the servo detectors successfully.

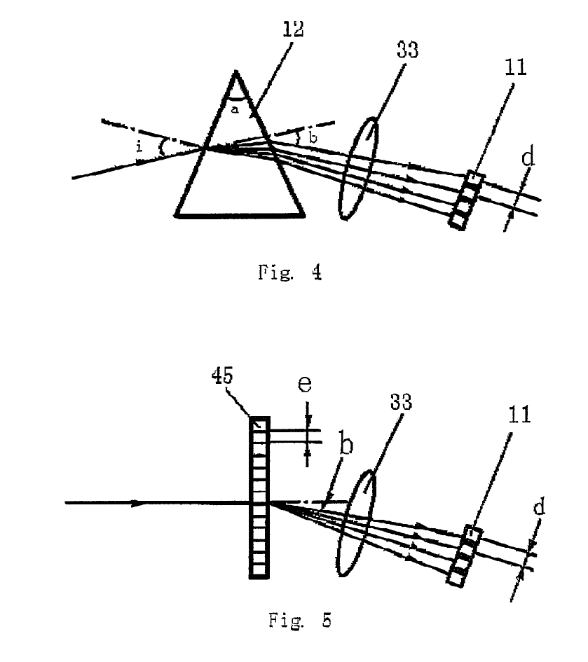

FIG. 4 is the first preferred splitter according to the invention. The isoceles triangle lens has two transparent slant. The apex angle of the isocels triangle lens is an acute angle. The incident multi-wavelength light is a coaxial collimated beam, which includes several different wavelength components. The multi-wavelength beam reaches one slant of the lens and is refracted into the lens, then reaches the other slant, after refracted the second time come out into air. In the exit beam, beam of different wavelengths deflects a different angle b to the incident beam, which means dispersion exists. The exit beam deflection angle b is related to the following factors: the lens apex angle a, the angle I between the incident beam and the lens surface normal line, lens material's refractive index n. The calculating formula of exit beam deflection angle b is : b=i'- aresin└n×sin(a−arc(singi/n))┘−a. After dispersed by the lens, the multi-wavelength beam focus on the linear photoelectic receiver array. The array is composed of several photoelectric detecting cells, the distance between each cell is d. If the object lens′ focus length is f, the difference value of two adjacent beams′ deflection angle is Δb, the distance d is given by d=f×tg (Δb).

In one example, the wavelength of four beams are 830 nm, 780 nm, 670 nm, 630 nm respectively. The lens′ apex angle is 60 degree. The incident angle I is 30 degree. The lens material is quartz glass, the refractive indice to four wavelength light are about 1.453,1.454,1.455,1.457. The deflection angles b of four wavelength are 38.668 degree, 38.813 degree, 38.960 degree, 39.256 degree, respectively. If the object lens′ s focus length is 30 mm, the difference value of two adjacent beams′ deflection angle is Δb, the cell distances of photoelectric detecting array are:76 μm, 77 μm, 155 μm, respectively.

FIG. 5 is the second preferred embodiment of this invention's beam splitter. The plane transmission-type diffraction grating rulings are rows of parallel lines, arrayed equally with the ruling span e, the ruling density is denoted as 1/e. The ruling density used in this scheme is among 200 to 1200 lines per millimeter. The incident multi-wavelength beam to the diffraction grating is a coaxial beam, its incident direction is vertical to the grating's surface. On the other side of the grating, the +1 or −1 order diffraction fringe has a deflection angle b. Because light of different wavelength has different deflection angle, dispersion is caused. The image-forming object lens focuses the +1 or −1 order diffraction fringe onto the linear photoelectric receiver array. When the object lens 33's focal length is f, the deflection angle difference value between two beam with adjacent wavelength is Δb, the cell span (d) of detector 11 is given by formula d=f×tg (Δb). Compared with lens splitting, grating splitting can get bigger dispersion angle, favoring the total architecture designing.

In one example, the transmission grating 45's ruling density N is 1000 lines/mm; the wavelength of incident four kind of light is 830 nm, 780 nm, 670 nm, 630 nm, respectively; the incident coaxial multi-wavelength collimated beam casts from a vertical angle onto one of the grating's surface. On the other surface, in the exit beams's +1 order diffraction, diffraction angle of four wavelength are calculated by the formula sinb=Nλ,where λ is the light wavelength. Diffraction angles gotten from the above parameters are: 56.009 degree, 51.261 degree, 41.067 degree, and 39.05 degree, respectively. The object lens 33 forms diffraction fringes′ image on photoelectric receiver arrays, the object lens 33′ a focal length is 10 mm, the cell span of photoelectric receiver arrays is: 830 μm, 1620 μm, 527 μm.

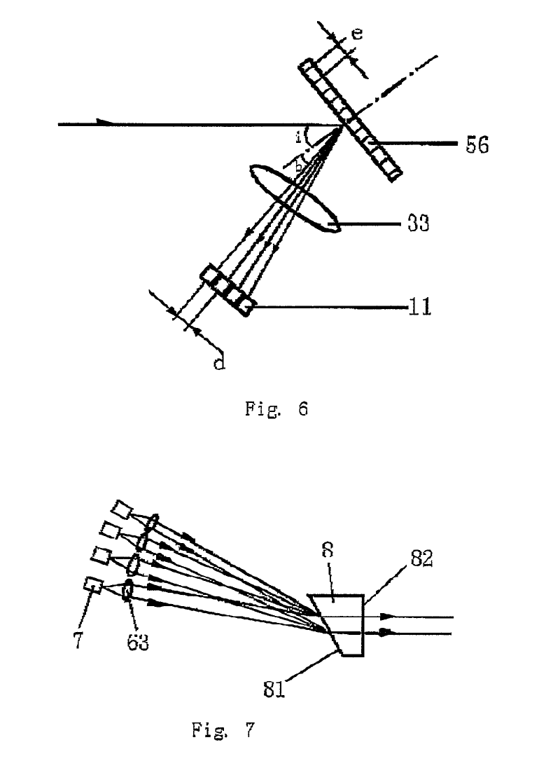

FIG. 6 is the most preferred embodiment of splitter according to the invention. The reflection plane diffraction grating 56's rulings are series of parallel lines, equally arrayed, the span of two rulings is e, the ruling density is expressed as N=1/e. The grating density used in this scheme is 200˜1200 lines per millimeter. The incident multi-wavelength beam casted over the grating′ s surface is coaxial collimated beam, its direction forms an acute angle with the diffraction grating′ s surface normal, ensuring +1 order or −1 order diffraction fringe to appear. In the +1+1 order or 1 order diffraction fringe, light beam with different wavelength exits from different diffraction angle b, causing the dispersion. In the grating′ s+1 order diffraction fringes, different wavelength light′ s diffraction angle b is calculated by the dispersion formula sini+sinb=N_{λ}, where λ is the wavelength. The image forming object lens focuses the +1 order or −1 order diffraction fringes to form images on the linear photoelectric receiver array. Supposing the cell span is d, object lens 13's focal length is f, the deflection angle between two beam with adjacent wavelength is Δb, then the distance d is given by formula d=f×tg (Δb). Compared with transmission grating, reflection grating has the priority of being made with structure of so-called blazed grating, which concentrates most energy on the diffraction orders needed, improving the light energy-utilizing ratio.

In one example, the grating ruling density N is 1000 lines/mm. The four kind of incident light's wavelength is separately 830 nm, 780 nm, 630 nm; the grating's +1 order diffraction fringe's diffraction angle b is calculated by dispersion formula sini+sinb=N_{α}. In this formula, I is the beam's incident angle, the angle between incident beam and grating surface normal; b is the angle between diffraction the beam and the grating surface normal. We can calculate from the above formula, when assume the incident angle 1 to be 30 degree, for beams whose wavelength are 830 n, 780 nm, 670 nm, 630 nm respectively. The dispersion angles are 19.269 degree, 16.260 degree, 9.788 degree, 7.470 degree. When the object lens 33's focal length is 10 mm, the cell span of the photoelectric detector array is calculated by the formula d=f ×tg(Δb), where Δb is the difference value of two wavelength-adjacent beams′ diffraction deflection angles. The calculation results are : 526 μm, 1134 μm, 405 μm respectively.

FIG. 7 is the first preferred embodiment of the beam combiner according to invention. These are N laser diodes array 7 lied in the same vertical face. The laser diode eradiate several beams, which pass through each collimating lens 63 to become parallel beams and reach the same location of the dispersion lens 8's incident face 81. The angle between the dispersion lens 8's incident face 81 and the exit face 82 (called the dispersion lens′ apex angle) is among 10 degree and 70 degree. After scattering by the dispersion lens, these beams are combined to one output coaxial parallel beam. The output coaxial parallel beam is vertical to the dispersion lens′ exit face 82. In order to output coaxial parallel beam is vertical to the dispersion lens′ exit face 82, according to the photorefraction dispersion theory, every laser beams′ incident angle should be set properly. Each beam shall be adjusted by micro collimating lens to a parallel beam before reaching the lens′ surface. In this embodiment, ZK14 glass is chosen as the dispersion lens′ material, wherein the lens′ apex angle is 30 degree. The four beam signals are parallel beams with each wavelength 780 nm, 650 nm, 550 nm, 480 nm, which reach the beam combining dispersion lens 8 from each incident angle 710 9′, 72019′, 74032′26″, 77016′8 ″ and form a multi-wavelength parallel beam.

In general, laser diodes emitting different wavelength light are integrated in a single chip. Laser diodes′ arrangement such as beam emitting directions must satisfy the coupling requirement. Lens shall adopt the material with higher dispersion factor. Lens and laser diodes′ integration structure can vary in different mode which are known by the skilled in the art. To reducing energy loss, every transparent surface of the lens should be coated with multi-color reflection reducing coating. Because the multi-wavelength optical disc's different layer comprises different recording material, the incident angles for different wavelength light are different, which can be calculated upon lens material, apex angle and wavelength.

FIG. 8 is the second embodiment of the beam combiner according to the invention. The beam combiner comprises laser diodes 71, 72, 73, and 74, collimating lens 631, 632, 633, and 634, and right angle lens 621, 622. The right angle lens 622's size is the half of lens 621. Laser diodes 71, 72, 73, 74 are located at focuses of collimating lens 631, 632, 633, 634 respectively, right angle 621, 622 are glued together as FIG. 5 shows. In other word, lens 622's right-angle side superpose lens 621's hypotenuse, and the former lens′ right-angle apex superpose the mid-point of lens 621's hypotenuse. The energy loss should be as little as possible when the light beam passes the glueing interface. Beams from laser diode 71, 72, 73, 74, passing through each collimating lens 631, 632, 633, 634, become parallel beams to output. Four beams exit in the same plane and are vertical to each neighboring beams. The exit parallel beam from collimating lens 631 reaches right-angle lens 621's incline 151, parallel beams from collimating lens 632, 633, 634, at an angle of 45 degree, shine onto right-angle 621,622's corresponding incident face, combined by right-angle lens 621,622 come out from the exit face 52 as multi-wavelength coaxial parallel beam.

Right-angle lens 621,622's tow right-angle sides and inclines not as unidirectional reflector, whose reflecting face (inside lens) is coated with mono-color or multi-color total reflection film, reflecting this mono-color or multi-color light signal; the transmission face (outside lens) is coated with reflection reducing coating. The collimating lens and right-angle lens can be produced in integrated optics′ method, or die stamping, to reduce the optical head's size and weight.

Those skilled in the art can easily know different beam combining schemes using the various lens assembling method. For example, use the multi-face unidirectional reflector to form a beam-combing device.

Persons in the art also know that the mask in high level non-linear photochromic material can reduce the facula of the beam, hence, to enhance the optical disc's storing density, this invention use the mask made in high level non-linear photochromic material in the multi-wavelength optical disc showed as FIG. 3.

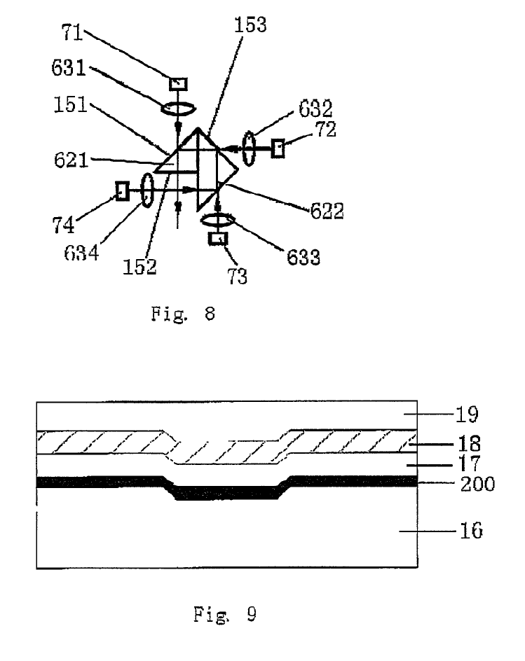

FIG. 9 is the optical disc will only one recording layer of photochromic material according in the invention. A mask layer 200 is sandwiched between the substrate 16 and the recording layer 17. A reflecting layer 18 is on the recording layer 17, protecting layer 19 protects the reflecting layer 18. The total thickness of mask layer and recording layer is less than the read-writing system's focal depth. The mask layer 200 mainly comprises high level non-linear photochromic material, which reduces the size of the formula of the longer wavelength beam on the recording layer. In this embodiment, the recording layer 17's thickness is 1000 nm, mask layer 200's is 50 nm, reflecting layer 18's is 50 nm, protecting layer's is 20 μm, and substrate is 1 mm. The mask layer comprises the pyrrole substitutive fulgide derivant.

Another embodiment in such disc is that there is not a mask layer 200, all the other are the same with the embodiment described. In the embodiment, the recording layer 17's thickness is 1000 nm, the reflecting layer 18's is 50 nm, the protecting layer's is 20 μm, and the substrate's is 1 mm.

In this embodiment, the one-layer recording layer 17 may comprise only one kind of photochronic material, therefor, the recording layer 17 is sensitive to optical signal of a wavelength. This one-layer recording layer can also comprise various kind of photochromic material, so that it is sensitive to optical signal with various wavelength. This recording layer 17 is sensitive to optical signal of multi-wavelength, its function is the same as that of the optical disc that will be described referred to FIG. 11.

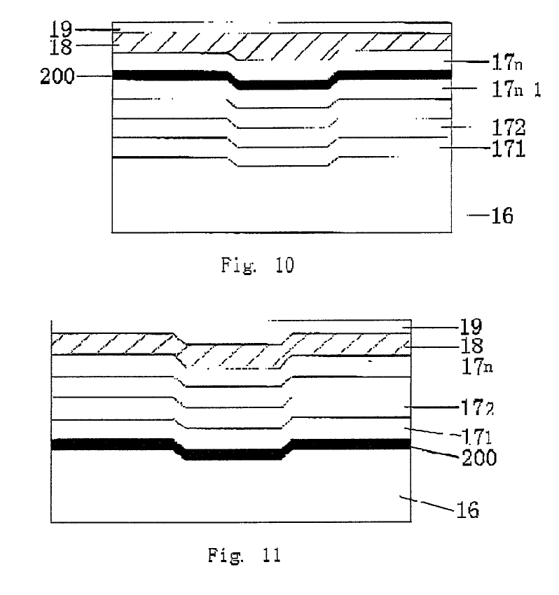

FIG. 10 is a drawing of a multi-layer multi-wavelength optical disc's structure. Recording layer 171,172, . . . , 17n−1, comprising different photochromic material, are sandwiched between substrate 16 and the mask layer 200. The recording layer 17n correspond to the light beam with the longest read-writing wavelength λn. A mask layer 200 is sandwiched between the nth recording layer and the (n−1)the recording layer. A reflecting layer 18 is on the recording layer 17n. All other features are the same as what are described above. The mask layer 200 only reduces the read-writing facula's size whose wavelength is λn, and does not effect faculas of other wavelengths. The total thickness of the above-mentioned mask layer and recording layer is less than the read-writing system's focal depth. In an embodiment, the thickness of each layer of 20 recording layer is 5 nm, the mask layer's thickness is 80 nm, the reflecting layer's is 60 nm, the protecting layer's is 30 μm, substrate's is 1.1 mm. The mask layer is spirooxazine derivant.

Another embodiment is an optical disc with only multi-layer multi-wavelength photochronic material recording layer, and no mask layer 200. Other features are the same as above. In this embodiment, the thickness of each of 10 recording layers is 60 nm, the reflecting layer's thickness of 60 nm, the protecting layer's is 30 μm, and the substrate's is 1.1 mm.

FIG. 11 is another embodiment of the multi-layer multi-wavelength optical disc with mask layer. All recording layers 171,172, . . . , 17n are sandwiched between a reflecting layer 18 and mask layer 200. The mask layer 200 is sandwiched between substrate 16 and the first recording layer 171. One of the read writing beam acts as “switching light”, causing super-diffraction-limit aperture in the recording layer, which can reduce the size of read-writing facula of all wavelength λI - λn, when the facula passes the mask layer. The mask layer and recording layer's total thickness is less than read-writing system's focal depth. In the embodiment, the thickness of each recording layer is 70 nm, the reflecting layer's thickness is 40 nm, the protecting layer's is 50 μm, the substrate's is 1.1 mm. The mask layer is spiropyran compound.

It is easy to know that the optical disc showed as FIG. 11 has the same function as the optical disc with only one recording layer 17 comprising various photochromic material.

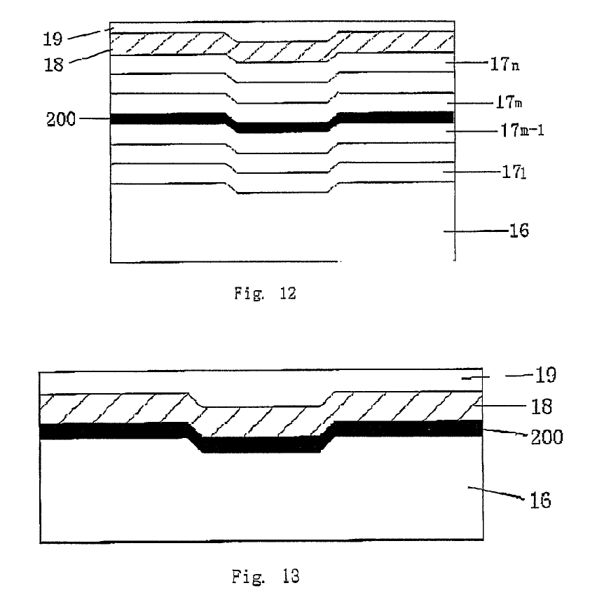

FIG. 12 is the third embodiment of the multi-layer multi-wavelength optical disc with mask layer. The mask layer is sandwiched between one of the internal recording layer 17m and 17m−1. All recording layers are sandwiched between the reflecting layer and the substrate. The mask layer reduces the read writing facula sizes on recording layer 17m˜17n, corresponding wavelength λm˜λn, and does not affect the facula of other wavelength. The mask layer and recording layer's total thickness is less than the read-writing system's focal depth. The mask layer 200's thickness is 50 nm, the reflecting layer's thickness is 50 nm, and the protecting layer's is 20 μm, the substrate s is 1 mm. The mask layer is pyrrole substitutive fulgide derivant.

FIG. 13 is a CD-ROM, the mask layer is sandwiched between substrate 16 and the reflecting layer 18. The read-out facula passes through mask layer 200 and forms the actual facula with size reduced on the information layer 16c which is a part of the substrate 16 and pre-stamped with information pits or other information features, for example, the information layer 16c may be photochromic materials which have been modulated by light beam with some information. The mentioned mask layer and recording layer's total thickness is less than the read-writing system's focal depth.

The mask layer mainly comprises photoelectric material. The mentioned information feature can represent signals of more than one wavelength.

In the first embodiment of such CD-ROM, the thickness of the mask layer, the reflecting layer, the protecting layer, and the substrate are 50 nm, 50 nm, 20 μm, and 1 mm, respectively. The mask layer is pyrrole substitutive fulgide derivant.

In the second embodiment of such CD-ROM, the mask layer's thickness is 80 nm, reflecting layer's is 50 nm, the protecting layer's is 30 μm, the substrate's is 1.1 mm. The mask layer is spirooxazine compound.

In the third embodiment, the mask layer's thickness is 70 nm, reflecting layers's is 40 nm, protecting layer's is 50 μm, substrate's is 1.1 mm. The mask layer is spiropyran compound.

Those skilled in the art shall know that photochromic material may include spiropyran, spirooxazine, fulgide, azo and other organic compound. The above-mentioned photochromic mask layer can prepared with surface spin coating process: dissolve photochromic compound, for example pyrrole substitutive fulgide derivant, in organic solvent, then spun-coates it onto the corresponding layer of the substrate which is pre-stamped with serving groove or information pits, all completes when the solvent votalized or dried.

As mentioned above, through the optical disc in the examples has the mask layer, it should be known that the mask layer is not indispensable for multi-wavelength optical disc. The shortcoming of optical disc without mask layer is there is a bigger facula of the beam on the disc, which affects the recording density but not the optical disc's multi-wavelength parallel reading and writing.

While the invention has been described in the context of preferred embodiments, it will be apparent to those skilled in the art that the present invention may be modified in numerous ways and may assume many embodiments other than that specifically set out and described above. Accordingly, it is intended by the appended claims to cover all modifications of the invention which fall within the true scope of the invention.

What is claimed is:

1. A multi-wavelength optical disc comprising:
a substrate comprising at least one information record layer on which optical signal consisting of at least one wavelength light beam components is recorded by modulating the layer's transmissivity for each of said components, wherein the information layers located within the focal depth of a objective lens for reading the disc when the disc is being read;
a reflective layer on the substrate to reflect the modulated optical signal; and
a protective layer on the reflective layer.

2. The multi-wavelength optical disc as in claim 1 further comprises a photochromic super-resolution mask layer sandwiched between the substrate and the reflective layer, the photochromic super-resolution mask layer comprising high-order non-linear photochromic materials, wherein all the information layers and the mask layer located within the focal depth of a objective lens for reading the disc when the disc is being read.

3. The multi-wavelength optical disc as in claim 1, wherein the information layer comprises photochromic materials.

4. The multi-wavelength optical disc as in claim 1, wherein the information layer being pre-stamped with information pits.

5. A multi-wavelength optical disc comprising:
a substrate;
at least one recording layer on the substrate, wherein siad at least one recording layer comprising at least one kind of photochromic material, said recording layers being orderly arranged one by one on the substrate if there are more than one recording layers, and said at least one recording layer located within the focal depth of a objective lens for reading or writing the disc when the disc is being read or written;
a reflective layer on the recording layers to reflect the light signal transparanced from the recording layer, and
a protective layer on the reflective layer.

6. The multi-wavelength optical disc as in claim 5 comprises one recording layer comprising the compound of at least two kinds of photochromic materials.

7. The multi-wavelength optical disc as in claim 5 wherein at least one of said at least one recording layer comprising the compound of at least two kinds of photochromic materials.

8. The multi-wavelength optical disc as in claim 5 wherein said at least one recording layer comprising the compound of organic compound of spiropyran, spirooxazine, fulgide or azo, or the mixture thereof.

9. The multi-wavelength optical disc as in claim 5, further comprises a photochromic super-resolution mask layer, and at least one of said recording layer(s) sandwiched between the photochromic super-resolution mask layer and the reflective layer; wherein the recording layers and the mask layer located within the focal depth of a objective lens for reading or writing the disc when the disk is being read or written.

10. The multi-wavelength optical disc as in claim 5 wherein said photochromic super-resolution mask layer comprises organic compounds of spiropyran or spirooxazine or fulgide or azo, or the mixture thereof.

11. The multi-wavelength optical disc as in claim 5 wherein the thickness of said at least one recording layer is between 5 nm - 1000 nm.

12. A apparatus for writing signal to a multi-wavelength disc, the multi-wavelength optical disc comprises a recording layer on which a multi-wavelength optical signal has been recorded, and a reflective layer on said recording layers; said apparatus comprises:
at least one monochromatic light source, and each one of said at least one monochromatic light source generating light beam with different wavelength;
a light beam combiner optically coupled to the light source for mulitiplying the light beam from said at least one monochronic source to a coaxial parallel light beam containing all said different wavelengths;
a beam focalizer optically coupled to the combiner for having the coaxial parallel light beam focussed on all said recording layers located within the focal depth, said multi-wavelength signals recording layers being recorded on said recording layers.

13. The apparatus for writing signal to a multi-wavelength disc as in claim 12, wherein, said beam combiner comprises a prism for superposing the collimated light beams from said at least one monochromatic resources to a coaxial parallel multi-wavelength beam.

14. The apparatus for writing signal to a multi-wavelength disc as in claim 12, wherein said beam focalizer further comprises at least one objective lens, the recording layers of the multi-wavelength disc being within the focal depth of said objective lens.

15. A apparatus for reading or writing signal recorded on or to the multi-wavelength disc comprising:
at least one monochromatic light source, and each one of said at least one monochromatic light source generating light beam with different wavelength;
a light beam combiner optically coupled to the light source for multiplying the light beam from said at least one monochromatic source to a coaxial parallel light beam containing all said different wavelengths;
a beam focalizer optically coupled to the combiner for having the coaxial parallel light beam focussed on all said recording layers of the disc located within the focal depth of the beam focalizer, said multi-wavelength signals recording layers being recorded on said recording layers;
a beam receiver optically coupled to the disc for receiving the coaxial parallel light beam reflected by the reflective layer;
a beam splitter optically coupled to the beam receiver for splitting the received coaxial parallel light beam from the beam receiver to monochromatic optical signals with different wavelengths;
at least one optical detector optically coupler to the beam splitter for detecting the split monochromatic optical signals.

16. The apparatus as in claim 15, wherein said beam combiner comprises a prism for superposing the collimated light beams from said at least one monochromatic resouces to a coaxial parallel multi-wavelength beam.

17. The apparatus as in claim 15, wherein said beam focalizer further comprises at least one objective lens, the recording layers of the multi-wavelength disc being within the focal depth of said objective lens.

18. The apparatus as in claim 15, wherein said monochromatic resource comprises a collimating lens for collimating the light beam from the monochromatic source.

19. The apparatus as in claim 16, wherein said prism in a dispersing prism.

20. The apparatus as in claim 19, wherein said dispersing prism is a dispersing prism wedge, combining the various monochromatic light beam with different incident angle to a coaxial parallel light beam.

21. The apparatus as in claim 20, wherein the vertex angle of the dispering prism wedge mentioned is between 10° and 70°.

22. The apparatus as in claim 21, wherein the dispering prism comprises quartz glass.

23. A method for writing a optical signal to a multi-wavelength optical disc, the multi-wavelength optical disc comprising a multi-wavelength recording layer comprising various photochomic materials, and a reflective layer on the mentioned recording layers, the recording layer located within the focal depth of a objective lens for focussing the signal on said recording layer; said method comprises steps of:
modulating each light source based upon the signal to be written to the disc to generate several light beams with different wavelength, the intensity of the light beams being above the photochromic threshold of the photochromic materials when the beam reaches the recording layer of the optical disc;
combining said light beams to one coaxial parallel light beam with different wavelength components;
adjusting the objective lens to have the recording layers of the disc located within the focal depth to focus the coaxial parallel light beam with different wavelength on the recording layer;
writing the optical signal to the recording layer, wherein each component of the coaxial parallel light beam with different wavelength components writing corresponding signal to the layer of the optical disc.

24. The method as in claim 23, wherein the steps of modulating each light source is a multistage modulation method.

25. A method for reading the data stored in a multi-wavelength optical disc, the multi-wavelength optical disc comprising a multi-wavelength recording layers comprising several kinds of photochromic materials, and a reflective layer on the recording layer, the recording layer located within the focal depth of a objective lens for focussing the signal on said recording layer; said method comprises steps of:
generating constant several light beams with different wavelength by several light source, the intensity of the beam being below the photochromic threshold of the photochromic materials when the beam reaches the recording layer of the optical disc;
combining the light beams to one coaxial parallel light beam with different wavelength components;
adjusting the objective lens to have the recording layers of the disc located within the focal depth to focus the coaxial parallel light beam with different wavelength on the recording layer;
modulating the coaxial parallel light beam by the recording layer to a modulated multi-wavelength coaxial parallel light beam, wherein different layer modulating the components with a corresponding wavelength;
splitting the modulated multi-wavelength coaxial parallel light beam with different wavelength components to several single-wavelength light beams;
detecting said several single-wavelength light beams.

26. The method as in claim 25 further comprises a step of reflecting the modulated multi-wavelength coaxial parallel light beam.
